(19) United States
(12) Patent Application Publication
(10) Pub. No.: US 2021/0216694 A1
(43) Pub. Date: Jul. 15, 2021

(54) Debugging non-detected faults using sequential equivalence checking

(71) Applicant: Synopsys, Inc., Mountain View, CA (US)

(72) Inventors: Sandeep Jana, Bengaluru (IN); Sudipta Kundu, Portland, OR (US); Pratik Mahajan, Santa Clara, CA (US)

(73) Assignee: Synopsys, Inc., Mountain View, CA (US)

(21) Appl. No.: 16/873,675

(22) Filed: Jan. 7, 2020

(30) Foreign Application Priority Data
Jan. 8, 2019 (IN) 201911000933

(51) Int. Cl. G06F 30/3323

(52) U.S. Cl. CPC G06F 30/3323; G06F 2119/16

(57) ABSTRACT

Techniques and systems for classifying non-detected faults (NDFs) in a formal verification test-bench are described. A sequential equivalence checking formulation can be constructed based on an integrated circuit (IC) design and a set of NDFs, wherein the set of NDFs do not falsify a first set of properties of the IC design, wherein said constructing the sequential equivalence checking formulation comprises creating a second set of properties based on the set of NDFs, wherein each property in the second set of properties corresponds to an NDF in the set of NDFs. A formal sequential equivalence checking tool can be used to prove the second set of properties in the sequential equivalence checking formulation. Next, for each property in the second set of properties that is disproven by the formal sequential equivalence checking tool, some embodiments can classify a corresponding NDF in the set of NDFs as an observable NDF.

### RELATED APPLICATION

This application claims benefit of Indian Provisional Application No. 201911000933, filed on 8 Jan. 2019, the contents of which are herein incorporated by reference in their entirety for all purposes.

### COPYRIGHT NOTICE

The assignee of this patent document does not object to the facsimile reproduction of the patent document as it appears in the files of the United States Patent and Trademark Office, but otherwise reserves all rights whatsoever in any included works of authorship protected by copyright.

### BACKGROUND

### Technical Field

This disclosure relates to integrated circuit (IC) design. More specifically, this disclosure relates to debugging non-detected faults using sequential equivalence checking.

### Related Art

Advances in process technology have fueled a rapid increase in the size and complexity of IC designs. This dramatic increase in complexity and integration densities has made it considerably more challenging to design ICs. The importance of IC design verification cannot be over-emphasized. Indeed, without IC design verification it would be impossible to have confidence in the correctness of large and complex ICs that are commonly found in today's computing devices.

One approach to verify an IC design is to exhaustively simulate the IC design over all possible inputs to ensure that the design produces the desired outputs. This approach is often impractical because it is computationally infeasible to exhaustively simulate non-trivial IC designs. Another approach is to use formal verification to prove that the IC design produces the desired outputs.

### SUMMARY

This section is not intended to limit the scope of the disclosed subject matter. The disclosed subject matter is to be accorded the widest scope consistent with the principles and features disclosed in the entire disclosure. Some embodiments described herein provide systems and techniques for automatically debugging non-detectable faults (NDFs) in a formal verification test-bench. More specifically, some embodiments described herein provide systems and techniques for automatically classifying NDFs into observable and non-observable NDFs, and automatically generating counter-example traces in a formal verification test-bench used for verifying an IC design.

Some embodiments can construct a sequential equivalence checking formulation based on an IC design and a set of NDFs, wherein the set of NDFs do not falsify a first set of properties of the IC design, wherein said constructing the sequential equivalence checking formulation comprises creating a second set of properties based on the set of NDFs, wherein each property in the second set of properties corresponds to an NDF in the set of NDFs. The embodiments can then use a formal sequential equivalence checking tool to prove the second set of properties in the sequential equivalence checking formulation. Next, for each property in the second set of properties that is disproven by the formal sequential equivalence checking tool, the embodiments can classify a corresponding NDF in the set of NDFs as an observable NDF.

In some embodiments, constructing the sequential equivalence checking formulation can comprise: (1) creating a first model that models the IC design, (2) creating a second model that models a mutated IC design with injected NDFs, (3) creating a set of assumptions, each assumption forcing an input of the first model to be equal to a corresponding input of the second model, (4) creating a set of assertions, each assertion requiring an output of the first model to be equal to a corresponding output of the second model, (5) adding a fault register, wherein each bit of the fault register corresponds to an enable signal that injects a corresponding NDF into the second model, and (6) creating the second set of properties based on the set of NDFs, wherein each property in the second set of properties can be expressed as reg[i]⇒A₁\hat{ }A₂Λ\hat{ }Aₘ, wherein reg[i] is the i^{th} bit of the fault register, reg, and A₁ through Aₘ are assertions in the set of assertions. The “⇒” symbol denotes logical implication and the “\hat{ }” symbol denotes logical conjunction (i.e., the logical AND operation).

In some embodiments, the formal sequential equivalence checking tool can provide a counter-example trace for each property in the second set of properties that is disproven, and the embodiments can provide the counter-example to a user.

### BRIEF DESCRIPTION OF THE FIGURES

FIG. 1 illustrates a process for classifying NDFs in accordance with some embodiments described herein.

FIG. 2 illustrates how a sequential equivalence checking formulation can be constructed for classifying NDFs in accordance with some embodiments described herein.

FIG. 3 illustrates a process for classifying NDFs in a formal verification test-bench used for verifying an IC design in accordance with some embodiments described herein.

FIG. 4 illustrates a computer system in accordance with some embodiments described herein.

### DETAILED DESCRIPTION

The following description is presented to enable any person skilled in the art to make and use the claimed invention(s), and is provided in the context of particular application(s) and/or environment(s). Various modifications to the disclosed embodiments will be readily apparent to those skilled in the art, and the general principles defined herein may be applied to other embodiments and applications without departing from the spirit and scope of the disclosure. Thus, the disclosed subject matter is not limited to the embodiments shown, but is to be accorded the widest scope consistent with the principles and features disclosed herein.

In this disclosure, numerous specific details may be described to enable one or more of the embodiments. In the interest of not obscuring the presentation of the embodiments, some features that are known in the art may be combined together, may be described in less detail, or may be implied (i.e., some well-known features may not be explicitly described). Furthermore, while this description may refer to some features in the singular tense, more than one instance of the feature may be illustrated in the figures, and like components are labeled with like numerals.

An IC design and manufacturing process produces IC chips. IC design software tools can be used to create an IC design. Once the IC design is finalized, it can undergo fabrication, packaging, and assembly to produce IC chips. The overall IC design and manufacturing process can involve multiple entities, e.g., one company may create the software for designing ICs, another company may use the software to create the IC design, and yet another company may manufacture IC chips based on the IC design. An IC design flow can include multiple steps, and each step can involve using one or more IC design software tools. An improvement to one or more of these steps in the IC design flow results in an improvement to the overall IC design and manufacturing process. Specifically, the improved IC design and manufacturing process can produce IC chips with a shorter time-to-market (TTM) and/or higher quality of results.

As an IC design progresses through an IC design flow, the IC design can be represented at different levels of abstraction by using different data formats or languages. In general, higher levels of abstraction contain fewer details of the IC design than lower levels of abstraction. Typically, the IC design is described at a high level of abstraction in the early stages of the IC design flow, and the level of abstraction becomes progressively lower as the IC design moves through the IC design flow (i.e., the description of the IC design becomes more specific as the IC design progresses through the IC design flow).

For example, toward the beginning of the IC design flow, an IC design can be described at a high level of abstraction by using a hardware description language (HDL) which describes the functionality of the IC design but does not include information about the actual geometric shapes that will be printed on the wafer. Toward the end of the IC design flow, the same IC design can be represented in a low level of abstraction by using a data format or language such as GDSII or OASIS, which contains a description of the actual geometric shapes that are to be printed on the wafer. In between these two ends of the IC design flow, the IC design may be represented in numerous data formats or languages that describe the same IC design at different levels of abstraction.

Some examples of IC design steps and the associated software tools are described below. These examples are for illustrative purposes only and are not intended to limit the embodiments to the forms disclosed. This disclosure describes techniques and systems that can be used in one or more IC design steps.

IC design software tools enable IC designers to describe the functionality that the IC designers want to implement. These tools also enable IC designers to perform what-if planning to refine functionality, check costs, etc. During logic design and functional verification, the HDL, e.g., SystemVerilog, code can be written and the design can be checked for functional accuracy, e.g., the design can be checked to ensure that it produces the correct outputs.

During synthesis and design for test, the HDL code can be translated to a netlist using one or more IC design software tools. Further, the netlist can be optimized for the target technology, and tests can be designed and implemented to check the finished chips. During netlist verification, the netlist can be checked for compliance with timing constraints and for correspondence (i.e., equivalence checking) with the Register Transfer Level (RTL) design and/or HDL code.

During design planning, an overall floorplan for the chip can be constructed and analyzed for timing and top-level routing. During physical implementation, circuit elements can be positioned in the layout and can be electrically connected.

During analysis and extraction, the IC design's functionality can be verified at a transistor level and parasitics can be extracted. During physical verification, the design can be checked to ensure correctness for manufacturing, electrical issues, lithographic issues, and circuitry.

During resolution enhancement, geometric manipulations can be performed on the layout to improve manufacturability of the design. During mask data preparation, the design can be “taped out” to produce masks which are used during fabrication.

In formal verification, a set of assumptions (or input constraints) can be defined to specify the allowed inputs, i.e., only those input combinations that satisfy the set of assumptions or constraints are allowed. Next, the design under verification (DUV) can be defined using a formal model. Finally, a set of properties (or assertions) can be defined to specify the desired behavior of the DUV.

In particular, a DUV can be modeled using a finite-state transition system, which can be formally defined as follows. A finite-state transition system S:(ī,x̅,I,T) can be described by a pair of propositional logic formulas: an initial condition I(x̅) and a transition relation T(ī,x̅,x̅′) over input variables ī, internal state variables x̅, and the next-state internal state variables x̅′. In this disclosure, a bar on top of a literal, e.g., “x̅”, indicates that the symbol, e.g., “x̅”, represents a vector of variables instead of just one variable. Also, adding the prime symbol (′) to an internal state variable represents the corresponding next-state variable, and adding the prime symbol to a formula, e.g., F′, is equivalent to adding the prime symbol to all of the variables in the formula. For the sake of brevity, the symbol for a formula is sometimes used in this disclosure without brackets, i.e., sometimes we use the symbol “F” instead of the more complete version “F(x̅)”.

A state of the DUV corresponds to an assignment of Boolean values to all internal state variables x̅. For example, a state can be represented by a conjunction of literals, wherein each literal is a state variable or its negation. An assignment s to all variables of a formula F either satisfies the formula, i.e., s|=F, or falsifies the formula, i.e., s|≠F. If s is interpreted as a state of a DUV and s|=F, then we say that s is an F-state.

A trace s₀, s₁, s₂, . . . , which may be finite or infinite in length, of a transition system S is a sequence of states such that s₀|=I, and for each adjacent pair (sᵢ, sᵢ₊ᵢ) in the sequence, sᵢ,sᵢ₊₁^{′}|=T. In other words, a trace is a sequence of states that corresponds to an execution of the transition system (and therefore corresponds to the execution of the DUV). A state is considered to be reachable if the state exists in some trace of the transition system. In other words, a reachable state is a state that can occur during normal execution of the DUV.

The desired behavior of a DUV can be described using a set of properties. Each property can be represented as a formula Pᵢ(x̅) that can be evaluated for a given state s. The goal of the formal verification system is to prove that all reachable states satisfy each property Pᵢ(x̅). In other words, each property Pᵢ(x̅) asserts that only Pᵢ-states are reachable and, for each property Pᵢ(x̅), the goal of the formal verification system is to either (1) prove property Pᵢ(x̅), i.e., prove that indeed only Pᵢ-states are reachable, or (2) disprove Pᵢ(x̅), e.g., by determining a finite counterexample trace s₀, s₁, s₂, . . . , sₖ, such that sₖ|≠Pᵢ.

A property can be a formula that is evaluated using the current values (i.e., the values in the current clock tick) of one or more internal state variables. Such properties can be used to describe relationships between internal state variables that must always hold, i.e., the relationships must hold in every clock tick. According to one definition, a clock tick is the smallest unit of time in which the digital state of the DUV can change. For example, a clock tick can correspond to a clock cycle if the DUV can change its digital state at every positive clock edge of the clock. A property can also be a statement in the formal system that is evaluated using the values of one or more internal state variables, wherein at least one variable value is evaluated at a clock tick that is different from the current clock tick. Such a property can be used to describe a behavior of the DUV that spans multiple clock ticks. In this disclosure, the term “property” can generally refer to any statement in a formal system that is desired to be proven.

Assumptions are statements in the formal system that can be used to constrain the state space, thereby potentially making it easier to prove or disprove properties. When assumptions are provided to a formal verification system, the formal verification system can try to prove a property by assuming the assumptions to be true. This allows the formal verification system to restrict the search space to only the set of states where the assumptions are true. For example, if the set of assumptions includes assumptions a₁, a₂, . . . , aⱼ, then instead of attempting to prove property Pᵢ without any assumptions, the formal verification engine can attempt to prove the statement α₁\hat{ }α₂Λ\hat{ }αⱼ ⇒Pᵢ which is likely to be easier to prove than proving property Pᵢ without any assumptions.

Formal verification has many applications. One specific type of a formal verification application involves sequential equivalence checking between two or more circuit designs that are specified at the same or different abstraction levels. The word “sequential” in the term “sequential equivalence checking” refers to the fact that the IC design that is being checked can include sequential circuit elements (e.g., registers) that are operated based on a clock signal. A sequential equivalence checking formulation can include properties that span multiple clock ticks. Note that sequential equivalence checking is typically performed when one IC design is transformed into another IC design, and it is desired to formally prove that the transformed design is equivalent to the original design. For example, sequential equivalence checking can be performed between an original RTL design and an optimized RTL design after register retiming, or between a design that is specified in a high-level programming language (e.g., C++) and an RTL design after the high-level design is compiled to obtain the RTL design.

Toward the end of a formal property verification flow, when the formal verification test-bench is mature, verification engineers are often required to quantify the quality of the properties and assertions that they have verified as part of the signoff process. Functional fault analysis technology is often used in this step. Behavioral faults can be systematically injected into the IC design code. In this signoff methodology, the formal verification tool can be used check if all the injected faults can be detected by the formal verification environment. Specifically, in this approach, all previously proven formal properties can be checked in the fault injected design.

A fault is “detected” if one of the properties is falsified. If not, then the fault is “non-detected.” The non-detected faults (NDFs) can help identify design logic where faults are not caught by any of the existing formal checkers, thereby quantifying the quality of the formal property verification environment. If all the formal checkers pass in the presence of a fault, then that indicates one or more weaknesses in the formal verification environment. The weaknesses can include, but are not limited to: a missing checker (e.g., a missing property), incomplete specification (e.g., the formal model does not completely and accurately model the DUV), or over-constraining (e.g., the set of assumptions is too restrictive, and so certain inputs that should be allowed are not allowed by the set of assumptions). The NDFs can provide guidance for further examination of the formal verification environment, for example, to add missing checker to catch an NDF. Further details on how fault injection can be used in conjunction with formal property verification can be found in U.S. Patent Pub. No. 2019/0147121, entitled “Efficient Mechanism for Interactive Fault Analysis in Formal Verification Environment,” which is herein incorporated by reference in its entirety for all purposes.

Although NDFs can identify weaknesses in the verification environment, the task of analyzing the NDFs, and determining the corrective action that needs to be taken can be daunting, especially when there are a large number of NDFs. Specifically, in the absence of an automated technique for debugging a large number of NDFs, debugging the NDFs would require manual analysis which is time consuming and error prone.

Some embodiments described herein provide techniques and systems for automatically debugging NDFs by performing sequential equivalence checking between an original design and a design mutated with NDFs on a cycle-by-cycle basis. Moreover, in some embodiments, every observable output fault leads to a counter-example trace, which can be used to quickly analyze weaknesses in a formal verification environment.

Specifically, when sequential equivalence checking is performed between the original design and the design mutated with NDFs on a cycle-by-cycle basis, the system can determine which of the NDFs causes a difference in the behavior of the output ports between the good and the faulty design. Such faults are observable at the outputs, and hence impact the behavior of the design. Therefore, it is essential to fix them first. Moreover, every fault that is observed in the output leads to a counter-example trace, which verification engineers can debug using a waveform to quickly analyze the weakness in their formal verification environment. In other words, some embodiments automate the classification of NDFs as observable and non-observable NDFs, thereby helping users to prioritize the order in which to fix weaknesses in the formal verification environment.

In the following discussion, the good design (i.e., the design that does not contain any injected faults, and for which a set of properties were proven) is named “spec,” and the fault-injected design is named “impl.” Additional constraints are created so that the inputs of “spec” are identical to the inputs of the “impl.” For example, if there are n input ports named IN1, IN2, . . . INn in “spec,” then n constraints can be created as follows:
C1: spec.IN1==impl.IN1
C2: spec.IN2==impl.IN2
. . .
Cn: spec.INn==impl.INn

The labels “C1” through “Cn” identify the n constraints. The notation “spec.IN1” refers to input “IN1” in “spec.” Therefore, the constraint “spec.IN1==impLIN1” forces the input “IN1” of “spec” to be equal to the input “IN1” of “impl” during formal verification.

Given identical inputs, the intent is to check if the good design and the fault-injected design produce identical outputs or not. If there are m output ports named OUT1,OUT2, . . . OUTm, then m additional assertions (or properties) can be created as follows:
A1: spec.OUT1==impl.OUT1
A2: spec.OUT2==impl.OUT2
Am: spec.OUTm==impl.OUTm

The labels “A1” through “Am” identify the m assertions. The notation “spec.OUT1” refers to output “OUT1” in “spec.” Therefore, the assertion (or property) “spec.OUT1==impl.OUT1” requires the output “OUT1” of “spec” to be equal to the output “OUT1” of “impl.”

Next, using formal verification, the impact of each of the NDFs can be checked on these m assertions given that the input constraints hold good. In order to achieve this, additional helper assertions can be created as follows. Suppose there are p NDFs that are desired to be checked. Each NDF can be represented by an individual bit of a register (e.g., “fault reg”), which can be added to the design by using the HDL statement, e.g., “[p-1:0] fault reg.”

For each NDF (which corresponds to fault reg[i]) injected in the design, a separate property can be created as follows: fault_prop_i: assert property (@ (posedge clk) fault reg[i]->(A1 && A2 && . . . && Am). Each NDF property (i.e., fault_prop_i) along with the added input constraints (i.e., C1-Cn) can then be provided to a formal sequential equivalence checking tool to check if, when a given NDF is enabled and the other NDFs are disabled, the enabled NDF falsifies any of the m output assertions. If at least one assertion is falsified, then it implies that the enabled NDF can cause a difference in the output behavior between the good design and the fault-injected design, i.e., the enabled NDF causes an observable difference in one or more outputs. (Note that this observable difference in the output did not falsify any of the original set of properties that were proven for the IC design, and this is why this particular fault was classified as an NDF.)

In such scenarios, the formal verification tool can create a counter-example waveform of the falsified assertion to show how the enabled NDF is propagated to the output (which causes the output of the fault-injected design to be different from the good design). Using this technique, the p NDFs can be automatically classified into observable and non-observable NDFs with counter-example waveforms for each of the observable NDFs. A user can then prioritize the observable NDFs, and use the corresponding counter-example waveform to debug and take necessary action.

In an example IC design, 379 faults were identified. Of these, 228 were NDFs and 151 were detected faults. In other words, at this point in the sign-off verification flow, the user had the enormous task of analyzing and debugging 228 NDFs to identify deficiencies in the formal verification test-bench. Without any additional guidance, the user may not know how to prioritize the 228 NDFs. Embodiments described herein can be used to classify the 228 NDFs into observable NDFs and non-observable NDFs. Specifically, for the example IC design mentioned above, embodiments described herein classified the 228 NDFs into 44 observable NDFs and 184 non-observable NDFs. In some situations, the user may decide to only work on the 44 observable NDFs, thereby potentially saving more than one man-month of work to figure out how to generate checkers or simulation patterns for the 184 non-observable NDFs. As a side benefit, embodiments described herein generate waveforms that showed scenarios under which the 44 observable NDFs propagate to at least one output, which is a great help for a user who is trying to debug the NDF. In this manner, embodiments described herein can provide guidance to a user for fixing deficiencies in the formal verification test-bench, e.g., by adding more properties to the test-bench.

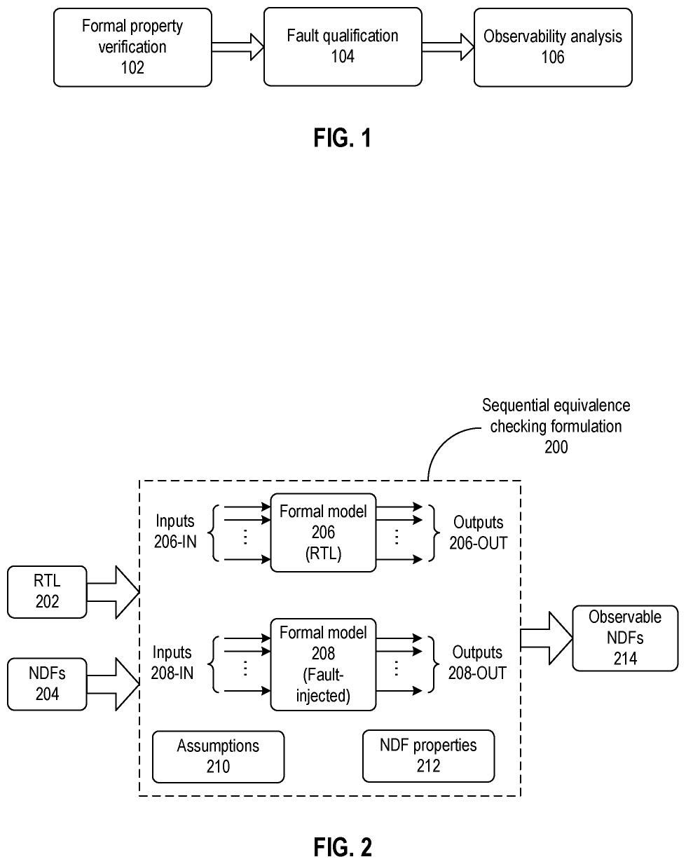

FIG. 1 illustrates a process for classifying NDFs in accordance with some embodiments described herein. Formal property verification (block 102) can be performed on an IC design. Next, fault classification (block 104) can be performed by using the properties that were proven during formal property verification. The fault classification (block 104) can output a set of NDFs. Techniques and systems for fault classification are described in (1) U.S. Patent Pub. 2018/0349521, entitled “Efficient Mechanism of Fault Qualification Using Formal Verification, and (2) U.S. Patent Pub. 2019/0147121, entitled “Efficient Mechanism for Interactive Fault Analysis in Formal Verification Environment,” and the contents of both of these U.S. Patent Publications are herein incorporated by reference in their entirety for all purposes. Next, embodiments described herein can then be used to perform observability analysis (block 106) to classify the NDFs that were identified during fault classification (block 104) into observable NDFs and non-observable NDFs.

FIG. 2 illustrates how a sequential equivalence checking formulation can be constructed for classifying NDFs in accordance with some embodiments described herein. RTL 202 contains the design, and faults 204 contains a set of NDFs that have been identified in the design and that are desired to be classified into observable and non-observable NDFs. Sequential equivalence checking formulation 200 can be constructed for this purpose. Specifically, after sequence equivalence checking formulation 200 has been constructed, it can be provided to a formal sequential equivalence checking tool. The output of the formal sequential equivalence checking tool can then be used to identify the observable NDFs 214 in NDFs 204.

Sequential equivalence checking formulation 200 can include formal model 206 which models the behavior of RTL 202, and formal model 208 which models the behavior of RTL 202 with mutations to model NDFs 204. For example, each fault may be injected as a version of the original circuitry with the fault, plus an enable signal. If the enable signal is asserted, the version with fault is selected. Otherwise, the version without fault is selected. Sequential equivalence checking formulation 200 includes assumptions 210 that force inputs 206-IN of formal model 206 to be equal to respective inputs 208-IN of formal model 208. Finally, sequential equivalence checking formulation 200 includes NDF properties 212, wherein each NDF property requires outputs 206-OUT of formal model 206 to be equal to respective outputs 208-OUT of formal model 208 when a corresponding NDF is enabled in formal model 208.

Once constructed, sequential equivalence checking formulation 200 can be provided to a formal sequential equivalence checking tool. If the formal sequential equivalence checking tool disproves an NDF property (selected from NDF properties 212), then the NDF corresponding to the NDF property is deemed to be observable. Additionally, when the formal sequential equivalence checking tool disproves an NDF property, it also provides a counter-example that can be outputted so that a user can use the counter-example to understand how the NDF propagates to one or more outputs of the DUV. This insight can significantly reduce the amount of time required by the user to fix deficiencies in the formal verification test-bench.

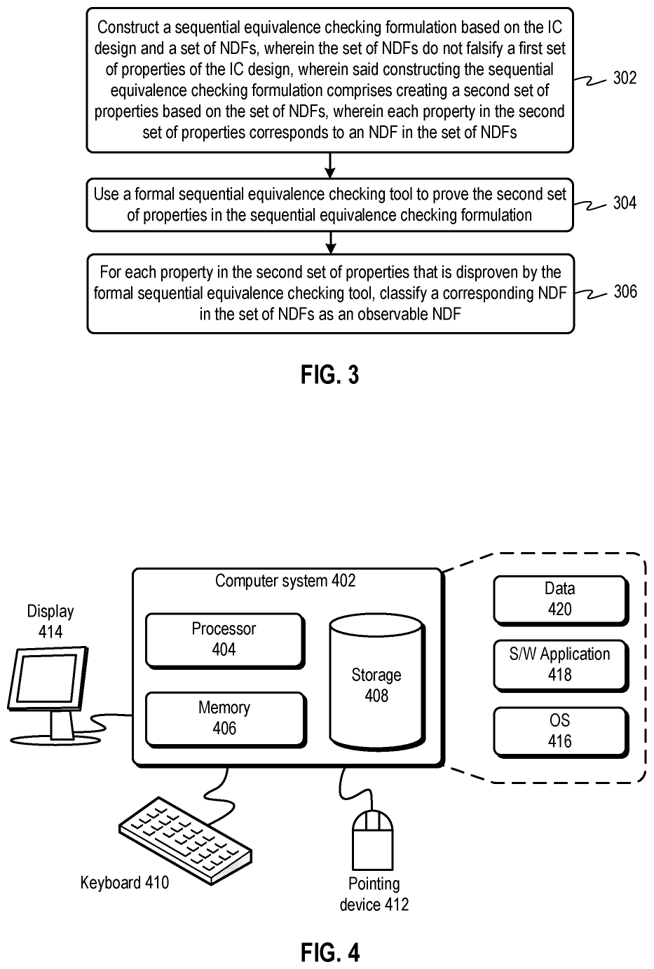

FIG. 3 illustrates a process for classifying NDFs in a formal verification test-bench used for verifying an IC design in accordance with some embodiments described herein. The process can begin by constructing a sequential equivalence checking formulation based on the IC design and a set of NDFs, wherein the set of NDFs do not falsify a first set of properties of the IC design, wherein said constructing the sequential equivalence checking formulation comprises creating a second set of properties based on the set of NDFs, wherein each property in the second set of properties corresponds to an NDF in the set of NDFs (operation 302).

In some embodiments, constructing the sequential equivalence checking formulation can comprise: (1) creating a first model that models the IC design, and a second model that models a mutated IC design with injected NDFs, (2) creating a set of assumptions, each assumption forcing an input of the first model to be equal to a corresponding input of the second model, (3) creating a set of assertions, each assertion requiring an output of the first model to be equal to a corresponding output of the second model, (4) adding a fault register, wherein each bit of the fault register corresponds to an enable signal that injects a corresponding NDF into the second model, and (5) creating the second set of properties based on the set of NDFs, wherein each property in the second set of properties is of the form reg[i]⇒A₁\hat{ }A₂Λ\hat{ }Aₘ, wherein reg[i] is the i^{th} bit of the fault register reg, and A₁ through Aₘ are assertions in the set of assertions.

The process can then use a formal sequential equivalence checking tool to prove the second set of properties in the sequential equivalence checking formulation (operation 304). Next, for each property in the second set of properties that is disproven by the formal sequential equivalence checking tool, the process can classify a corresponding NDF in the set of NDFs as an observable NDF (operation 306). In some embodiments, the formal sequential equivalence checking tool provides a counter-example trace for each property in the second set of properties that is disproven, and wherein the method further comprises providing the counter-example to a user.

FIG. 4 illustrates a computer system in accordance with some embodiments described herein. The term “computer” or “computer system” generally refers to a hardware-based system that can perform computations required for the design and manufacture of ICs. Computer system 402 can include processor 404, memory 406, and storage device 408. Computer system 402 may include multiple processors, and processor 404 may include multiple cores. Specifically, memory locations in memory 406 can be addressable by processor 404, thereby enabling processor 404 to access (e.g., via load/store instructions) and manipulate (e.g., via logical/floating point/arithmetic instructions) the data stored in memory 406. Computer system 402 can be coupled to display device 414, keyboard 410, and pointing device 412. Storage device 408 can store operating system 416, software application 418, and data 420. Data 420 can include input required by software application 418 and/or output generated by software application 418.

Computer system 402 may automatically (or with user help) perform one or more operations that are implicitly or explicitly described in this disclosure. Specifically, computer system 402 can load software application 418 into memory 406, and software application 418 can then be used to identify observable NDFs in a set of NDFs. The resulting IC design is expected to have better performance and/or quality of results (QoR) because observable NDFs were identified using embodiments described herein, thereby providing guidance to the user to efficiently improve the quality and effectiveness of the formal property verification test-bench.

While ‘data’ and ‘information’ often are used interchangeably (e.g., ‘data processing’ and ‘information processing’), the term ‘datum’ (plural ‘data’) typically signifies a representation of the value of a measurement of a physical quantity (e.g., the current in a wire), or the answer to a question (e.g., “yes” or “no”), while the term ‘information’ typically signifies a structured set of data (often times signified by ‘data structure’). A specified data structure is used to structure an electronic device to be used as a specific machine as an article of manufacture (see In re Lowry, 32 F.3d 1579 [CAFC, 1994]). Data and information are physical, for example binary data (a ‘bit’, usually signified with ‘0’ and ‘1’) enabled with two different levels of voltage in a circuit. For example, data can be enabled as an electrical, magnetic, optical or acoustical signal; a quantum state such as spin that enables a ‘qubit’; or a physical state of an atom or molecule. All such data and information, when enabled, are stored, accessed, transferred, combined, compared, or otherwise acted upon, actions that require energy.

As used herein, the term ‘process’ signifies an unnatural sequence of physical actions and/or transformations (both also referred to as ‘operations’ or ‘steps’) to produce at least one result. The actions and transformations are technical applications of one or more natural laws of science or unnatural laws of technology. The actions and transformations often change the physical state of a machine, of structures of data and information, or of a composition of matter. Two or more actions can occur at about the same time, or one action can occur before or after another action, if they produce the same result. A description of the physical actions and/or transformations that comprise a process are often signified with a set of gerund phrases (or their semantic equivalents) that are typically preceded with the signifier ‘the steps of’ (e.g., “a process comprising the steps of measuring, transforming, partitioning and then distributing . . . ”). The signifiers ‘algorithm’, ‘method’, ‘procedure’, ‘(sub)routine’, ‘protocol’, ‘recipe’, and ‘technique’ often are used interchangeably with ‘process’, and 35 U.S.C. 100 defines a “method” as one type of process that is, by statutory law, always patentable under 35 U.S.C. 101. Many forms of knowledge, learning, skills and styles are authored, structured, and enabled-objectively-as processes—e.g., knowledge and learning as functions in knowledge programming languages. As used herein, the term ‘rule’ signifies a process with at least one conditional test (signified, e.g., by ‘IF test THEN process’). As used herein, the term ‘thread’ signifies a sequence of operations or instructions that comprise a subset of an entire process. A process can be partitioned into multiple threads that can be used at or about at the same time.

As used herein, the term ‘component’ (also signified by ‘part’, and typically signified by ‘element’ when described in a patent text or diagram) signifies a physical object that is used to enable a process in combination with other components. For example, electronic components are used in processes that affect the physical state of one or more (‘ensemble’) electromagnetic or quantum particles/waves (e.g., electrons, photons) or quasiparticles (e.g., electron holes, phonons, magnetic domains) and their associated fields or signals. Electronic components have at least two connection points to which are attached ‘leads’, typically a wire with one end attached to the component and the other end attached to another component, typically as part of a circuit with current flows. There are at least three types of electrical components: passive, active and electromechanical. Passive electronic components typically do not introduce energy into a circuit—such components include resistors, memristors, capacitors, magnetic inductors, crystals, Josephson junctions, transducers, sensors, antennas, waveguides, etc. Active electronic components require a source of energy and can inject energy into a circuit—such components include semiconductors (e.g., diodes, transistors, optoelectronic devices), vacuum tubes, batteries, power supplies, displays (e.g., LEDs, LCDs, lamps, CRTs, plasma displays). Electromechanical components affect current flow using mechanical forces and structures—such components include switches, relays, protection devices (e.g., fuses, circuit breakers), heat sinks, fans, cables, wires, terminals, connectors and printed circuit boards. As used herein, the term ‘netlist’ is a specification of the components comprising an electric circuit, and electrical connections between the components. The programming language for the SPICE circuit simulation program is often used to specify a netlist. In the context of circuit design, the term ‘instance’ signifies each time a component is specified in a netlist.

One of the most important components as goods in commerce is the integrated circuit, and its res of abstractions. As used herein, the term ‘integrated circuit’ signifies a set of connected electronic components on a small substrate (thus the use of the signifier ‘chip’) of semiconductor material, such as silicon or gallium arsenide, with components fabricated on one or more layers. Other signifiers for ‘integrated circuit’ include ‘monolithic integrated circuit’, ‘IC’, ‘chip’, ‘microchip’ and ‘System on Chip’ (‘SoC’). Types of integrated circuits include gate/logic arrays, processors, memories, interface chips, power controllers, and operational amplifiers. The term ‘cell’ as used in electronic circuit design signifies a specification of one or more components, for example, a set of transistors that are connected to function as a logic gate. Cells are usually stored in a database, to be accessed by circuit designers and design processes.

As used herein, the term ‘module’ signifies a tangible structure for acting on data and information that typically is limited in size and/or complexity. For example, the term ‘module’ can signify one or more processes that transforms data and information, for example, processes comprising a computer program. The term ‘module’ also can signify one or more interconnected electronic components, such as digital logic devices. A process comprising a module, if specified in a programming language, such as System C or Verilog, also can be transformed into a specification for a structure of electronic components that transform data and information that produce the same result as the process. This last sentence follows from a modified Church-Turing thesis, which is simply expressed as “Whatever can be transformed by a (patentable) process and a processor, can be transformed by a (patentable) equivalent set of modules.”, as opposed to the doublethink of deleting only one of the “(patentable)”.

A module is permanently structured (e.g., circuits with unalterable connections), temporarily structured (e.g., circuits or processes that are alterable with sets of data), or a combination of the two forms of structuring. Permanently structured modules can be manufactured, for example, using Application Specific Integrated Circuits (‘ASICs’) such as Arithmetic Logic Units (‘ALUs’), Programmable Logic Arrays (‘PLAs’), or Read Only Memories (‘ROMs’), all of which are typically structured during manufacturing. For example, a permanently structured module can comprise an integrated circuit. Temporarily structured modules can be manufactured, for example, using Field Programmable Gate Arrays (FPGAs—for example, sold by Xilink or Intel's Altera), Random Access Memories (RAMs) or microprocessors. For example, data and information is transformed using data as an address in RAM or ROM memory that stores output data and information. One can embed temporarily structured modules in permanently structured modules (for example, a FPGA embedded into an ASIC).

Modules that are temporarily structured can be structured during multiple time periods. For example, a processor comprising one or more modules has its modules first structured by a manufacturer at a factory and then further structured by a user when used in commerce. The processor can comprise a set of one or more modules during a first time period, and then comprise a different set of one or modules during a second time period. The decision to manufacture or implement a module in a permanently structured form, in a temporarily structured form, or in a combination of the two forms, depends on issues of commerce such as cost, time considerations, resource constraints, tariffs, maintenance needs, national intellectual property laws, and/or specific design goals. How a module is used is mostly independent of the physical form in which it is manufactured or enabled. This last sentence also follows from the modified Church-Turing thesis.

As used herein, the term ‘processor’ signifies a tangible data and information processing machine for use in commerce that physically transforms, transfers, and/or transmits data and information, using at least one process. A processor consists of one or more modules (e.g., a central processing unit, ‘CPU’; an input/output (I/O′) controller, a memory controller, a network controller, and other modules). The term ‘processor’ can signify one or more processors, or one or more processors with multiple computational cores/CPUs, specialized processors (for example, graphics processors or signal processors), and their combinations. Where two or more processors interact, one or more of the processors can be remotely located. Where the term ‘processor’ is used in another context, such as a ‘chemical processor’, it will be signified and defined in that context.

The processor can comprise, for example, digital logic circuitry (for example, a binary logic gate), and/or analog circuitry (for example, an operational amplifier). The processor also can use optical signal processing, DNA transformations or quantum operations, microfluidic logic processing, or a combination of technologies, such as an optoelectronic processor. For data and information structured with binary data, any processor that can transform data and information using the AND, OR and NOT logical operations (and their derivatives, such as the NAND, NOR, and XOR operations) also can transform data and information using any function of Boolean logic. A processor such as an analog processor, such as an artificial neural network, also can transform data and information. No scientific evidence exists that any of these technological processors are processing, storing and retrieving data and information, using any process or structure equivalent to the bioelectric structures and processes of the human brain.

The one or more processors also can use a process in a ‘cloud computing’ environment, where time and resources of multiple remote computers are shared by multiple users or processors communicating with the computers. For example, a group of processors can use at least one process available at a distributed or remote system, these processors using a communications network (e.g., the Internet, or an Ethernet) and using one or more specified interfaces (e.g., an application program interface (′APP) that signifies functions and data structures to communicate with the remote process).

As used herein, the term ‘computer’ and ‘computer system’ (further defined below) includes at least one processor that, for example, performs operations on data and information such as (but not limited to) the AND, OR and NOT logical operations using electronic gates that can comprise transistors, with the addition of memory (for example, memory structured with flip-flops using the NOT-AND or NOT-OR operation). Such a processor is Turing-complete and computationally universal. A computer can comprise a simple structure, for example, comprising an I/O module, a CPU, and a memory that performs, for example, the process of inputting a signal, transforming the signal, and outputting the signal with no human intervention.

As used herein, the term ‘programming language’ signifies a structured grammar for specifying sets of operations and data for use by modules, processors and computers. Programming languages include assembler instructions, instruction-set-architecture instructions, machine instructions, machine dependent instructions, microcode, firmware instructions, state-setting data, or either source code or object code written in any combination of one or more higher level languages, for example, the C programming language and similar general programming languages (such as Fortran, Basic, Javascript, PHP, Python, C++), knowledge programming languages (such as Lisp, Smalltalk, Prolog, or CycL), electronic structure programming languages (such as VHDL, Verilog, SPICE or SystemC), text programming languages (such as SGML, HTML, or XML), or audiovisual programming languages (such as SVG, MathML, X3D/VRML, or MIDI), and any future equivalent programming languages. As used herein, the term ‘source code’ signifies a set of instructions and data specified in text form using a programming language. A large amount of source code for use in enabling any of the claimed inventions is available on the Internet, such as from a source code library such as Github.

As used herein, the term ‘program’ (also referred to as an ‘application program’) signifies one or more processes and data structures that structure a module, processor or computer to be used as a “specific machine” (see In re Alappat, 33 F3d 1526 [CAFC, 1991]). One use of a program is to structure one or more computers, for example, standalone, client or server computers, or one or more modules, or systems of one or more such computers or modules. As used herein, the term ‘computer application’ signifies a program that enables a specific use, for example, to enable text processing operations, or to encrypt a set of data. As used herein, the term ‘firmware’ signifies a type of program that typically structures a processor or a computer, where the firmware is smaller in size than a typical application program, and is typically not very accessible to or modifiable by the user of a computer. Computer programs and firmware are often specified using source code written in a programming language, such as C. Modules, circuits, processors, programs, and computers can be specified at multiple levels of abstraction, for example, using the SystemC programming language, and have value as products in commerce as taxable goods under the Uniform Commercial Code (see U.C.C. Article 2, Part 1).

A program is transferred into one or more memories of the computer or computer system from a data and information device or storage system. A computer system typically has a device for reading storage media that is used to transfer the program, and/or has an interface device that receives the program over a network. This process is discussed in the General Computer Explanation section.

The signifier ‘commercial solution’ signifies, solely for the following paragraph, an engineering domain-specific (and thus non-preemptive—see Bilski): electronic structure, a process for a specified machine, a manufacturable circuit (and their Church-Turing equivalents) or a composition of matter that applies science and/or technology in commerce to solve a technical problem.

The signifier ‘abstract’ (when used in a patent claim for any enabled embodiments disclosed herein for a new commercial solution that is a scientific use of one or more laws of nature {see Benson}, and that solves a problem of technology {see Diehr} used in commerce—or improves upon an existing commercial solution {see Diehr})—is precisely defined by the inventor(s) {see MPEP 2111.01 (9th edition, Rev. 08.2017)} as follows:

a) a new commercial solution is ‘abstract’ if it is not novel (e.g., it is so well known in equal prior art {see Alice} and/or the use of equivalent prior art solutions is long prevalent {see Bilski} in science, engineering or commerce), and thus unpatentable under 35 U.S.C. 102, for example, because it is ‘difficult to understand’ {see Merriam-Webster definition for ‘abstract’ } how the commercial solution differs from equivalent prior art solutions; or

b) a new commercial solution is ‘abstract’ if it is obvious, that is, if the existing prior art includes at least one analogous prior art solution {see KSR}, or the existing prior art includes at least two prior art publications that can be combined {see Alice} by a skilled person {often referred to as a ‘PHOSITA’, see MPEP 2141-2144 (9th edition, Rev. 08.2017)} to be equivalent to the new commercial solution, and is thus unpatentable under 35 U.S.C. 103, for example, because it is ‘difficult to understand’ how the new commercial solution differs from a PHOSITA-combination/-application of the existing prior art; or

c) a new commercial solution is ‘abstract’ if it is not disclosed with a description that enables its praxis, either because insufficient guidance exists in the description, or because only a generic implementation is described {see Mayo} with unspecified components, parameters or functionality, so that a PHOSITA is unable to instantiate an embodiment of the new solution for use in commerce, without, for example, requiring special programming {see Katz} (or, e.g., circuit design) to be performed by the PHOSITA, and is thus unpatentable under 35 U.S.C. 112, for example, because it is ‘difficult to understand’ how to use in commerce any embodiment of the new commercial solution.

The Detailed Description signifies in isolation the individual features, structures, functions, or characteristics described herein and any combination of two or more such features, structures, functions or characteristics, to the extent that such features, structures, functions or characteristics or combinations thereof are enabled by the Detailed Description as a whole in light of the knowledge and understanding of a skilled person, irrespective of whether such features, structures, functions or characteristics, or combinations thereof, solve any problems disclosed herein, and without limitation to the scope of the Claims of the patent. When an embodiment of a claimed invention comprises a particular feature, structure, function or characteristic, it is within the knowledge and understanding of a skilled person to use such feature, structure, function, or characteristic in connection with other embodiments whether or not explicitly described, for example, as a substitute for another feature, structure, function or characteristic.

In view of the Detailed Description, a skilled person will understand that many variations of the claimed inventions can be enabled, such as function and structure of elements, described herein while remaining in the domain of the claimed inventions. One or more elements of an embodiment can be substituted for one or more elements in another embodiment, as will be understood by a skilled person. Writings about embodiments signify their uses in commerce, thereby enabling other skilled people to similarly use in commerce.

This Detailed Description is fitly written to provide knowledge and understanding. It is neither exhaustive nor limiting of the precise structures described, but is to be accorded the widest scope consistent with the disclosed principles and features. A skilled person can enable many equivalent variations. Without limitation, any and all equivalents described, signified or Incorporated By Reference in this patent application are specifically Incorporated By Reference into the Detailed Description. In addition, any and all variations described, signified or Incorporated By Reference with respect to any one claimed invention and its embodiment also are included with all other claimed inventions and their embodiments. Any such variations include both currently known variations as well as future variations, for example any element used for enablement includes a future equivalent element that provides the same function, regardless of the structure of the future equivalent element.

It is intended that the domain of the set of claimed inventions and their embodiments be defined and judged by the following Claims and their equivalents. The Detailed Description includes the following Claims, with each Claim standing on its own as a separate claimed invention. The embodiments of the claimed inventions can have more structure and features than are explicitly specified in the Claims.

The foregoing embodiments have been presented for purposes of illustration and description. They are not intended to be exhaustive or to limit the scope of this disclosure to the forms disclosed. Accordingly, many modifications and variations will be apparent to practitioners skilled in the art. Additionally, the above disclosure is not intended to limit the disclosed subject matter. The scope of the claimed invention(s) is defined by the appended claims.

What is claimed is:

1. A non-transitory computer-readable storage medium storing instructions that, when executed by a computer, cause the computer to perform a method for classifying non-detected faults (NDFs) in a formal verification test-bench used for verifying an integrated circuit (IC) design, the method comprising:
constructing a sequential equivalence checking formulation based on the IC design and a set of NDFs, wherein the set of NDFs do not falsify a first set of properties of the IC design, wherein said constructing the sequential equivalence checking formulation comprises creating a second set of properties based on the set of NDFs, wherein each property in the second set of properties corresponds to an NDF in the set of NDFs;
using a formal sequential equivalence checking tool to prove the second set of properties in the sequential equivalence checking formulation; and
for each property in the second set of properties that is disproven by the formal sequential equivalence checking tool, classifying a corresponding NDF in the set of NDFs as an observable NDF.

2. The non-transitory computer-readable storage medium of claim 1, wherein said constructing the sequential equivalence checking formulation comprises creating a first model that models the IC design, and a second model that models a mutated IC design with injected NDFs.

3. The non-transitory computer-readable storage medium of claim 2, wherein constructing the sequential equivalence checking formulation comprises creating a set of assumptions, each assumption forcing an input of the first model to be equal to a corresponding input of the second model.

4. The non-transitory computer-readable storage medium of claim 2, wherein said constructing the sequential equivalence checking formulation comprises creating a set of assertions, each assertion requiring an output of the first model to be equal to a corresponding output of the second model.

5. The non-transitory computer-readable storage medium of claim 4, wherein said constructing the sequential equivalence checking formulation comprises adding a fault register, wherein each bit of the fault register corresponds to an enable signal that injects a corresponding NDF into the second model.

6. The non-transitory computer-readable storage medium of claim 5, wherein each property in the second set of properties can be expressed as reg[i] A₁\hat{ }A₂\hat{ }Λ\hat{ }Aₘ, wherein reg[i] is the i^{th} bit of the fault register, reg, and A₁ through Aₘ are assertions in the set of assertions.

7. The non-transitory computer-readable storage medium of claim 1, wherein the formal sequential equivalence checking tool provides a counter-example trace for each property in the second set of properties that is disproven, and wherein the method further comprises providing the counter-example trace to a user.

8. An apparatus, comprising:
a processor; and
a non-transitory computer-readable storage medium storing instructions that, when executed by the processor, cause the apparatus to perform a method for classifying non-detected faults (NDFs) in a formal verification test-bench used for verifying an integrated circuit (IC) design, the method comprising:
constructing a sequential equivalence checking formulation based on the IC design and a set of NDFs, wherein the set of NDFs do not falsify a first set of properties of the IC design, wherein said constructing the sequential equivalence checking formulation comprises creating a second set of properties based on the set of NDFs, wherein each property in the second set of properties corresponds to an NDF in the set of NDFs;
using a formal sequential equivalence checking tool to prove the second set of properties in the sequential equivalence checking formulation; and
for each property in the second set of properties that is disproven by the formal sequential equivalence checking tool, classifying a corresponding NDF in the set of NDFs as an observable NDF

9. The apparatus of claim 8, wherein said constructing the sequential equivalence checking formulation comprises creating a first model that models the IC design, and a second model that models a mutated IC design with injected NDFs.

10. The apparatus of claim 9, wherein constructing the sequential equivalence checking formulation comprises creating a set of assumptions, each assumption forcing an input of the first model to be equal to a corresponding input of the second model.

11. The apparatus of claim 9, wherein said constructing the sequential equivalence checking formulation comprises creating a set of assertions, each assertion requiring an output of the first model to be equal to a corresponding output of the second model.

12. The apparatus of claim 11, wherein said constructing the sequential equivalence checking formulation comprises adding a fault register, wherein each bit of the fault register corresponds to an enable signal that injects a corresponding NDF into the second model.

13. The apparatus of claim 12, wherein each property in the second set of properties can be expressed as reg[i]⇒A₁\hat{ }A₂Λ\hat{ }Aₘ, wherein reg[i] is the i^{th} bit of the fault register, reg, and A₁ through Aₘ are assertions in the set of assertions.

14. The apparatus of claim 8, wherein the formal sequential equivalence checking tool provides a counter-example trace for each property in the second set of properties that is disproven, and wherein the method further comprises providing the counter-example trace to a user.

15. A method for classifying non-detected faults (NDFs) in a formal verification test-bench used for verifying an integrated circuit (IC) design, the method comprising:
constructing, by using a computer, a sequential equivalence checking formulation based on the IC design and a set of NDFs, wherein the set of NDFs do not falsify a first set of properties of the IC design, wherein said constructing the sequential equivalence checking formulation comprises creating a second set of properties based on the set of NDFs, wherein each property in the second set of properties corresponds to an NDF in the set of NDFs;
using a formal sequential equivalence checking tool to prove the second set of properties in the sequential equivalence checking formulation; and
for each property in the second set of properties that is disproven by the formal sequential equivalence checking tool, classifying a corresponding NDF in the set of NDFs as an observable NDF.

16. The method of claim 15, wherein said constructing the sequential equivalence checking formulation comprises creating a first model that models the IC design, and a second model that models a mutated IC design with injected NDFs, wherein the formal sequential equivalence checking tool provides a counter-example trace for each property in the second set of properties that is disproven, and wherein the method further comprises providing the counter-example trace to a user.

17. The method of claim 16, wherein constructing the sequential equivalence checking formulation comprises creating a set of assumptions, each assumption forcing an input of the first model to be equal to a corresponding input of the second model.

18. The method of claim 16, wherein said constructing the sequential equivalence checking formulation comprises creating a set of assertions, each assertion requiring an output of the first model to be equal to a corresponding output of the second model.

19. The method of claim 18, wherein said constructing the sequential equivalence checking formulation comprises adding a fault register, wherein each bit of the fault register corresponds to an enable signal that injects a corresponding NDF into the second model.

20. The method of claim 19, wherein each property in the second set of properties can be expressed as reg[i]⇒A₁\hat{ }A₂Λ\hat{ }Aₘ, wherein reg[i] is the i^{th} bit of the fault register, reg, and A₁ through Aₘ are assertions in the set of assertions.
